(19) United States
(12) Patent Application Publication
(10) Pub. No.: US 2011/0066556 A1
(43) Pub. Date: Mar. 17, 2011

(54) Method and System for Intelligent Job Assignment Through an Electronic Communications Network

(76) Inventor: Albert Kadosh, Prescott, AZ (US)

(21) Appl. No.: 12/713,901

(22) Filed: Feb. 26, 2010

Related U.S. Application Data
(63) Continuation-in-part of application No. 12/559,968, filed on Sep. 15, 2009.

(51) Int. Cl. G06Q 10/00; G06Q 30/00; G06F 17/30; G06F 15/16

(52) U.S. Cl. 705/80; 705/347; 705/9; 705/11; 705/32; 707/752; 707/E17.064; 709/206

(57) ABSTRACT

A method and system for intelligent job assignment between multiple assignees and at least one client through an electronic communications network is disclosed. The method enables a business to consistently and systematically provide its customers with the best possible quality, in the shortest period of time, at the lowest possible cost, at any given time, given its current talent pool. The method includes ordering a database of qualifying assignees with a highest qualifying assignee ordered most significantly. The method also includes assigning a client's job to the most significant assignee and receiving feedback to from the client concerning an assignee's job performance and computing a cumulative qualifying value for the assignee based on the performance feedback included with any feedback received from any other client.

### CROSS-REFERENCE TO RELATED APPLICATION

This application is a continuation-in-part of and claims the benefit of the priority date of earlier filed U.S. Utility patent application Ser. No. 12/559,968, filed Sep. 15, 2009 for Method and System for Translation Workflow Management Across the Internet, incorporated herein by reference in its entirety.

### BACKGROUND OF THE INVENTION

Many corporations and even small businesses are outsourcing work across the internet to trim overhead costs, and to increase business operating efficiencies. Others are letting their staff work from home with internet access to attract or retain talented staff. With the advent of the internet and cheap access to it, employees and contractors no longer need to be physically located in a central building nor even be physically close to each other.

However, managing in such a distributed environment creates management issues that did not exist before. Issues relating to employee productivity and top-down communication between management and staff have become problematic with managers and employees at different sites, or even in different cities, states, or countries. Also, issues relating to customer satisfaction and product delivery, inventory and cost accounting have become more complex. These problems become more acute when there are many jobs belonging to many different clients, being managed by a single administrator.

Managers of large numbers of employees often rely on weekly reports from their staff to keep on top of business progress. Also, many managers rely on meetings with their customers for business deliverables and receivables. Therefore, management may rely on the accuracy of the information reported to them from their staff and/or from their customers in the static week to week management of their business. Also, management is often resource restricted in determining how often they collect data from their staff and customers to give them an accurate picture of resources, materials and schedule.

Therefore, some managers have taken advantage of the internet to improve communication via email and even in many cases to communicate with clients solely via email. However, this does not fully utilize the power and capabilities of the internet nor does it quickly provide the necessary information a manager needs to be able to make critical management decisions. Rather, such managers are all too often consumed in reading emails, and organizing meetings rather than managing their staff according to the best information available in the production of valuable goods and services.

Furthermore, in many instances the cost of having a manger make routine job assignment decisions unnecessarily raises costs to the business and to the consumer and wastes productive time without adding appreciable value. It is therefore desirable to have an intelligent, automated method to match up customer jobs to the employee(s) best able to quickly and accurately process the job for the customer.

### SUMMARY OF THE INVENTION

A method for intelligent job assignment between multiple assignees and at least one client through an electronic communications network is disclosed. The method includes ordering a database of qualifying job assignees with a highest qualifying assignee ordered most significantly. The method also includes assigning a client's job to a most significant assignee and receiving feedback from the client concerning the assignee's job performance and computing a cumulative qualifying value for the assignee based on the performance feedback included with any feedback received from any other client.

Embodiments of a computer program product are described comprising a computer readable medium having computer useable program code executable to perform operations for intelligent job assignment between multiple assignees and at least one client. The operations of the computer program product include choosing a job category characterizing a job the client needs to have performed and prioritizing a performance rating category preferred by the client. Another operation includes ordering a database of qualifying assignees within the job category based on the prioritized rating category, a highest rated assignee ordered most significantly. The computer program product further includes assigning the client's job to the most significant assignee within the job category based on the prioritized performance rating and receiving rating feedback from the client concerning the assignee's job performance in at least quality, speed and cost. The computer program product also includes computing a performance rating value for the assignee based on the performance rating feedback included with any performance rating value received from any other client.

In another embodiment, a method is described for managing the workflow of a translation agency between an administrator, multiple customers and multiple translators. The method includes computing a weighted value for each translator based on at least one of a translation quality rating, a translation speed rating, a translation cost rating, and a dependability rating, where the ratings are set by the administrator. The method also includes generating a dynamic availability for each translator using a translator's availability profile and a result of a number of words already assigned for translation to a translator divided by a translator's translation speed set by the administrator. The method further includes assigning a customer text file to a translator for translation based on a translator's weighted value and dynamic availability and a number of words in the customer text file. Other embodiments of the method are also described.

Embodiments of a system are also described. In one embodiment, the system is a system for managing translation workflow in a translation agency between an administrator, multiple customers and multiple translators. The workflow management system includes a customer interface on the internet, a translator interface on the internet, and an administrator interface coupled to the customer interface and to the translator interface over the internet but accessible only by the administrator. The customer interface is configured to receive a customer text file and a customer profile from a customer. The translator interface is configured to convey a translator's daily availability and to receive a translated file from a translator based on the customer text file. The administrator interface is configured to manage a plurality of customer text files and a plurality of translated files between the customer interface and the translator interface based on a computed weighted value and a dynamic availability for each translator. Other embodiments of the system are also described.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a flow chart of a method in accordance with an embodiment for translation workflow management of a translation agency between an administrator, multiple customers and multiple translators.

FIG. 2 depicts a flow chart of a method in accordance with an embodiment for determining the assignment of a customer text file to one of many translators for translation into another language.

FIG. 3 depicts a diagram of a method in accordance with an embodiment for establishing a weighted range and selecting point values from the weighted range.

FIG. 4 depicts a diagram of a method in accordance with an embodiment for establishing a weighted range and selecting point values from the weighted range for dynamic availability.

FIG. 5 depicts a diagram of a method in accordance with an embodiment for computing a weighted value including dynamic availability as a point value and as a qualifier.

FIG. 6 depicts a diagram in accordance with an embodiment for a translation workflow management system of managing translation workflow in a translation agency between an administrator, multiple customers and multiple translators.

FIG. 7 depicts a diagram in accordance with an embodiment of an administrator's interface of the translation workflow management system.

FIG. 8 depicts a diagram in accordance with an embodiment of a translator busy chart of the translation workflow management system.

FIG. 9 depicts a diagram in accordance with an embodiment of a pull-down screen configured to allow the administrator to establish a weighted range for all translators and to select point values for each of the translators.

FIG. 10 depicts a diagram in accordance with an embodiment of a screen of accounting information in the translation workflow management system.

FIG. 11 depicts a diagram in accordance with an embodiment of a format for a management screen used by the customer, the translator and the administrator of the translation workflow management system.

FIG. 12 depicts a flow chart of a method in accordance with an embodiment for intelligent job assignment between multiple assignees and at least one client through an electronic communications network.

FIG. 13 depicts the operations of a computer program product in accordance with an embodiment for intelligent job assignment between multiple assignees and at least one client through an electronic communications network.

FIG. 14 depicts a diagram of a method in accordance with an embodiment for intelligent job assignment further including averaging and storing assignee job performance ratings and prioritizing an averaged rating.

FIG. 15 is a block diagram of a system in accordance with an embodiment for intelligent job assignment between multiple assignees and at least one client through an electronic communications network.

FIG. 16 depicts a client assigning multiple jobs to multiple assignees in two job categories in accordance with an embodiment of the present disclosure.

Throughout the description, similar reference numbers may be used to identify similar elements depicted in multiple embodiments. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

A translation agency may employ a number of independent contractors who work for the agency on a per job basis. The translation agency may also employ a number of payroll translators including hourly and salaried employees. The administrator of such a translation agency may also have a number of various clients having many small documents and various large documents needing translation into another language. In order to efficiently match a translator with a customer text file and translate the largest volume of customer texts possible, a translation workflow management method, system and computer program product has been developed. The disclosure herein facilitates and automates the process of assigning jobs to translators in a manner which enables a business to consistently and systematically provide its customers with the best possible quality, in the shortest period of time, at the lowest possible cost, at any given time, given its current talent pool. In the disclosed embodiments below, the translation workflow management method and system may be fully automated or semi-automated by electronic or other means. The degree of automation realized is a function of the needs of the translation agency and is by no means limited by the disclosed embodiments.

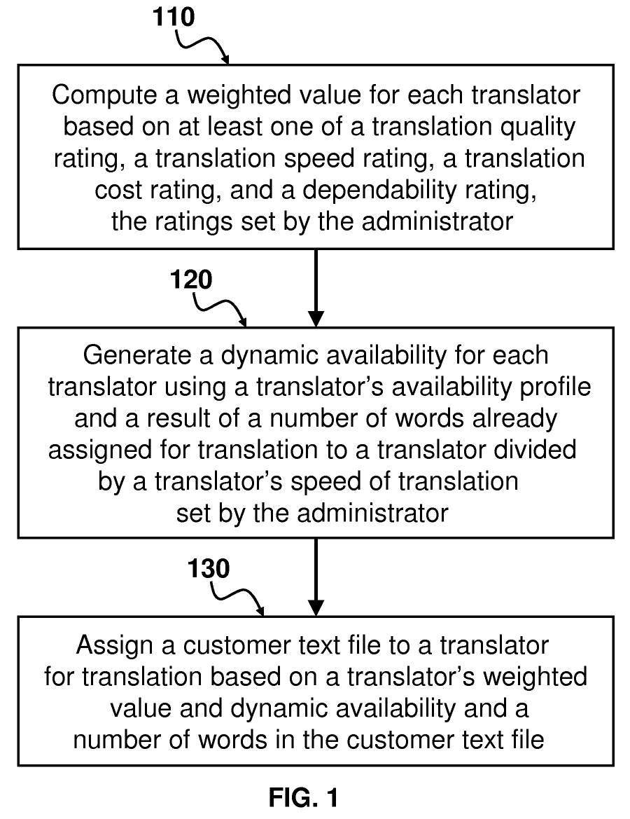

FIG. 1 depicts a flow chart of an embodiment for a method of translation workflow management of a workflow agency between an administrator, multiple customers and multiple translators through an electronic communications network. The network may comprise personal computers, workstations, servers, microprocessors, microcontrollers and other programmable electronic devices and data processing machines and machines to transform data and information from one state or form into another. The communications network may also include personal digital assistants, and cellular and landline telephonic devices. The communications network may also include phone lines, wireless telephonic electronics, and other forms of communication technology between electronic devices and data processing machines such as infrared, and optical communications devices. The method includes computing 110 a weighted value for each translator based on at least one of a translation quality rating, a translation speed rating, a translation cost rating, and a dependability rating. The ratings are initially set by the administrator when hiring an employee or contractor according to a translator's skills as determined by widely accepted industry standard tests and evaluation methods. The weighted value for a translator is automatically computed to include the priority or weight the administrator places on a rating relative to the other ratings and dependability. The weighted value allows the administrator to also prioritize business objectives such as translation quality over translation speed and dependability over translation cost.

The disclosed method also includes generating 120 a dynamic availability automatically for each translator using a translator's availability profile and the result of a number of words already assigned for translation to a translator divided by a translator's translation speed set by the administrator. The translator's availability profile alone may indicate he is immediately available for work, but may not include the work the translator currently has been assigned. The automatic division of the number of words assigned to the translator by the translator's daily capability will yield a quantity of time which is added to the availability indicated by the translator's profile to automatically generate the dynamic availability.

The method of FIG. 1 further includes automatically assigning 130 a customer text file to a translator for translation based on a translator's weighted value and dynamic availability and the number of words in the customer document. A translator having the highest weighted value and who is the soonest available may be automatically assigned a typical customer document for translation. However, a very large customer document may render a translator temporarily unavailable. In these cases, the method may include breaking up large customer text files into smaller pieces and assigning the smaller pieces to several translators. Therefore, the disclosed method may automatically update each translator's dynamic availability according to how many words each is assigned from the partitioned customer text file.

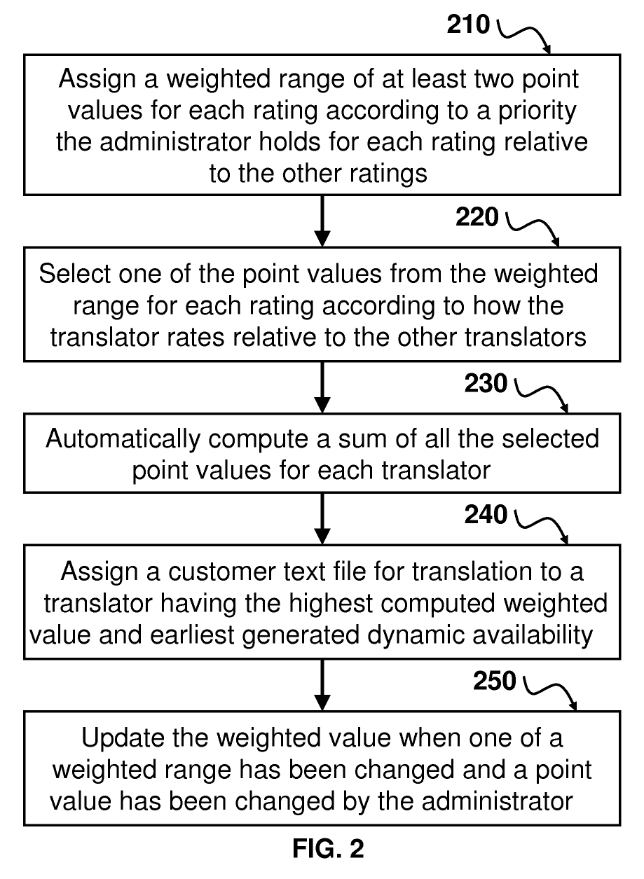

FIG. 2 depicts a flow chart of a method in accordance with an embodiment for determining the assignment of a customer text file to one of many translators for translation into another language. Therefore, the translation workflow management method of claim 1 further includes establishing 210 a weighted range of at least two point values for each rating according to a priority the administrator holds for each rating relative to the other ratings. The weighted range may be established for all translators in the agency at once. The embodiment further includes selecting 220 one of the point values from the weighted range for each rating for each translator according to how the translator rates relative to the other translators. The embodied method allows the administrator to initially select only a weighted point value from the established range and therefore assign jobs to the translation agency's translator pool according to predetermined business objectives.

The embodied method further includes automatically computing 230 the weighted value from the sum of all the selected point values for each translator and automatically assigning 240 a customer text file for translation to a translator having the highest computed weighted value and the earliest generated dynamic availability. Also updating 250 the weighted value when one of a weighted range has been changed and a point value has been changed by the administrator is included in accordance with the embodied method. This may occur when a change to the agency's translator pool has occurred with employee development or with hiring and reduction in force events.

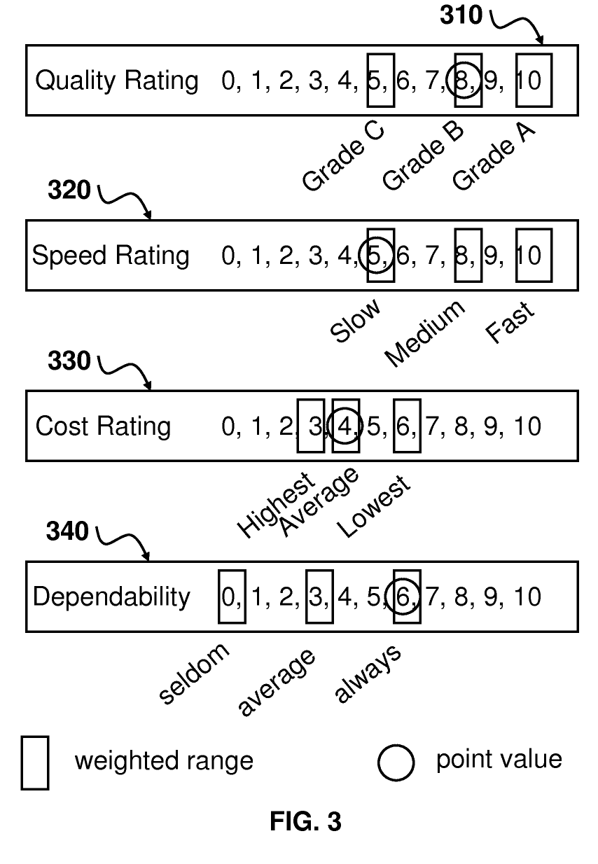

FIG. 3 depicts a diagram of an embodiment of a method for establishing a weighted range and selecting point values from the weighted range. The diagram includes the ratings: translation quality 310, translation speed 320, translation cost 330, and dependability 340. The administrator initially establishes a weighted range of three point values depicted inside squares. The administrator establishes the weighted range according to the importance a rating has to the administrator relative to the other ratings. Therefore the administrator may emphasize or prioritize a rating by establishing higher point values to select from when rating a translator. Other embodiments may include weighted ranges of as few as two point values or may include weighted ranges of as many as 3 or 4 or more. The same weighted range of point values for a rating is chosen by the administrator for all translators at once but may be changed by the administrator. It is only the selection of a particular point value, depicted by a circle, for a specific translator that is unique to the translator. The weighted range applies to all translators and is the same for all translators. Once a weighted range and specific point values have been initially chosen by the administrator, a translator's weighted value is automatically computed each time a customer text file is to be automatically assigned.

Per FIG. 3, the administrator has initially chosen a grade A quality rating to be assigned a 10 point value, a grade B quality rating to be assigned an 8 point value, and a grade C rating to be assigned a 5 point value. Only the assigned point values indicated by a square may be subsequently selected by the administrator, indicated by a circle, to be included in the automatic computation of the weighted value for each translator. The administrator subsequently selects the point value 8, depicted by a circle, corresponding to a grade B for a certain translator. In making this selection, the administrator may take into account the quality of translation the translator has performed for the administrator and also the quality of translation the translator has performed for other translation agencies. An administrator having higher priority for translation cost or dependability may establish lower point values for the A, B, and C grades relative to translation cost or dependability.

For the same translator as above, the administrator has initially chosen a ‘fast’ translation speed rating to be assigned a 10 point value, a ‘medium’ translation speed rating to be assigned an 8 point value, and a ‘slow’ translation speed rating to be assigned a 5 point value. The administrator subsequently selects the point value 5, depicted by a circle, corresponding to a ‘slow’ translation speed for the translator. In making this selection, the administrator may take into account translation speed measured from turn around time of a customer text file into another language and the size of the customer text file as measured by the number of source language words it contains. In determining the number of words a customer text file contains, automated electronic methods may be employed in an embodiment.

Continuing with FIG. 3, the administrator has initially chosen a ‘lowest’ translation cost rating to be assigned a 6 point value, an average translation cost rating to be assigned a 4 point value, and a highest translation cost rating to be assigned a 3 point value. The administrator subsequently selects the point value 4, depicted by a circle, corresponding to an average translation cost for the translator. In making this selection, the administrator may take into account the fees the translator charges to the translation agency and any overhead cost to the agency for employing the translator.

The administrator has initially chosen an always dependable rating to be assigned a 6 point value, an average dependability rating to be assigned a 3 point value, and a seldom dependable rating to be assigned a 3 point value. The administrator subsequently selects the point value 6, depicted by a circle, corresponding to an always dependable rating for the translator. In making this selection, the administrator may take into account how often the translator delivers a translated file on schedule or according to contract.

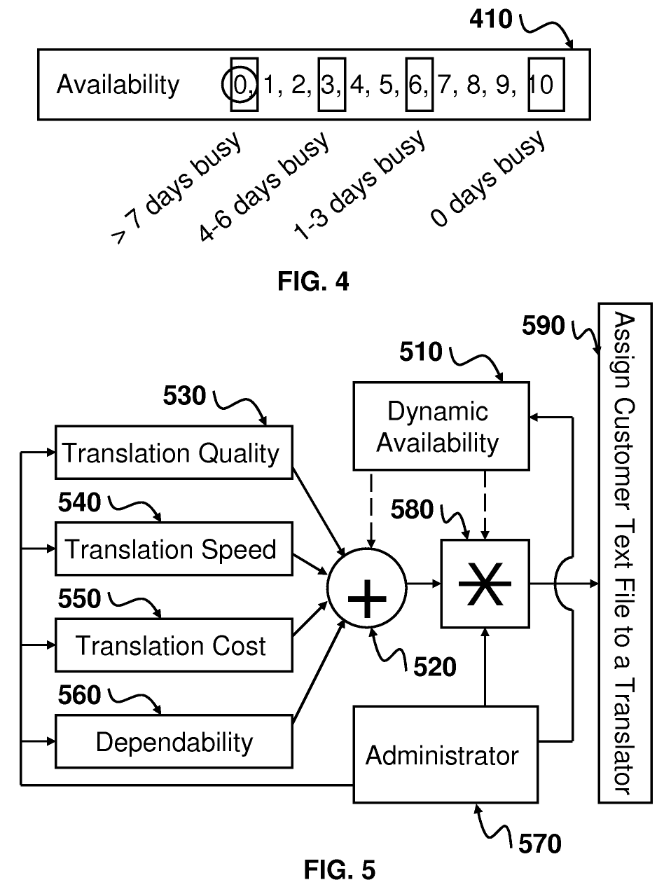

FIG. 4 depicts a diagram of an embodiment of a method for establishing a weighted range and selecting point values from the weighted range for dynamic availability. The embodied method includes initially establishing a weighted range of at least two point values for the dynamic availability 410 for all translators according to a priority the administrator holds for the dynamic availability relative to the other ratings. It also includes automatically determining one of the point values from the weighted range for the dynamic availability for each translator according to the value automatically generated for the dynamic availability. A customer text file may therefore be automatically assigned for translation to a translator having the highest computed weighted value based on the automatic sum of the selected point values for the ratings and the automatically determined point value for the dynamic availability.

A translator's dynamic availability is automatically updated when at least one of an event occurs of assigning an additional customer text file to a translator, assigning a translated file to a translator for revision, changing a translator's speed of translation, changing a translator's availability profile, removing a translator from the translation agency, and any event the administrator deems appropriate.

A translator's profile may be initially established by the translator or by the administrator. The profile may include a translator's status as a payroll or contracted employee. It may also include a daily capability and a daily availability including the translator's vacation, personal time, sick time and hours per day the translator expects to be available to translate. The translator's profile may be updated by the translator at any time and result in an automatic regeneration of a translator's dynamic availability.

The administrator has initially chosen 0 days busy to be assigned a 10 point value, 1-3 days busy to be assigned a 6 point value, 4-6 days busy to be assigned a 3 point value and over 7 days busy to be assigned a 0 point value. The generated dynamic availability therefore automatically determines the point value 0, depicted by a circle, corresponding to a translator being over 7 days busy. The administrator may bypass the automatic determination of the dynamic availability point value when necessary to take into account other factors such as unscheduled training and mentoring time for junior and senior translators respectively.

FIG. 5 depicts an embodiment of a method of computing a weighted value including dynamic availability as a point value and as a qualifier. Dynamic availability 510, may be included in a first mode by the first dashed arrow into the sum computation 520 with the ratings translation quality 530, translation speed 540, translation cost 550, and dependability 560. The first mode is typically used for assigning independent contractors paid by the job. The first mode adds dynamic availability with the 3 ratings and dependability in making the assignment. Dynamic availability may separately be included by the second dashed arrow in a second mode as a qualifying input to the multiplier product 580 used to assign a customer text file to a translator 590. The second mode is typically used to assign a customer text file to hourly or salaried paid employees on payroll. Therefore, the administrator may input a translator's status as a contractor or a payroll employee in the translator's profile. Accordingly, a customer text file may be automatically assigned to a translator through the first or second modes based on the translator's status as a payroll or contracted employee.

The administrator may have input into or set the dynamic availability, the translation quality, the translation speed, the translation cost and dependability. The administrator may also infrequently override the final product 580 of the weighted value indicated by the arrow input from the administrator 570 into the final product 580. An administrator employing hourly full-time payroll translators may choose to include the full-time or part-time status of employees as a qualifying multiplier to avoid paying a full-time employee who does not have any documents to translate. In other words, when customer files are available for translation they are assigned to the translator with the highest weighted value who is qualified by his or her availability. Therefore, where independent contractors are employed on a per job basis, their full-time or part-time status may be included in computing the weighted value for assigning a customer document.

In the second mode, for example, a ‘translator 1’ who scores a 23 in summation block 520 (see FIG. 3 circled values), but is not available for over 7 days will get a multiplier of zero and a total score of 0 (23*0=0) and therefore will not get assigned a new customer text file until he starts to become available. Another translator, say ‘translator 2’, who scores a 13 in block 520 (all lowest possible point values in FIG. 3) but is 0 days busy, will get a qualifying multiplier of 10 and therefore 13*10=130 points total score and get assigned the customer text file job.

On the other hand, translator 2 who is always available but scores very low in the 3 ratings and dependability may scarcely get a job in the first mode because other translators rating higher but who are very busy may still outscore him. For example, in the first mode, translator 1 scores a 23 with 0 points for availability and without a 0 multiplier totals 23 points. Translator 2 scores his 13 points plus 10 for his 0 days busy, for a total of 23. In this case there is a tie, but should the administrator have established a 9 point value for 0 days busy, translator 2 would have lost out on the assignment. A tie between a payroll employee and a contracted employee is automatically decided in favor of the payroll employee. In the event there is a tie between a contracted employee and another contracted employee, the administrator may decide the assignment.

An embodiment of the disclosed method includes non-routinely assigning a customer text file to a translator for translation based on any factor chosen by the administrator. An administrator may choose to base assignment on the customer rather than on the translator where a preferred customer may get a preferred translator. Therefore, FIG. 5 includes a bypass option, also known above as the override option, whereby the administrator may qualify a translator on any factor of the administrator's choosing and override the computed final product of the weighted value and dynamic availability altogether. Also, the administrator may change an assignment of a customer text file from an assigned translator to another translator based on any factor chosen by the administrator, either arbitrary or customer or client related.

An embodiment of the disclosed translation workflow management method further includes automatically conveying an assigned customer text file to a respective translator via a translator interface coupled to an administrator interface and to a customer interface. The interfaces are typically electronic but are not limited to electronic means. The customer text file is received at the customer interface by an upload of a customer text file submitted for translation by the respective customer. Likewise, a file translated from a customer text file by a translator is received at the translator interface by an upload of a submitted translated file from a respective translator. Additionally, an assigned customer text file and a respective translated file may be conveyed to a reviser via a reviser interface coupled to the administrator interface when a translator's translation quality rating falls below a set threshold. Similarly, a revised translated file may be received from the reviser at the reviser interface by an upload of a submitted revised file. The revised translated file may therefore be automatically conveyed to the administrator via the administrator interface.

There exists an embodiment of the translation workflow management method disclosed for managing multiple customer text files and multiple translated files between the customers and the translators over the internet in batch mode. Batch mode also facilitates auto-deleting a customer text file and a translated file older than an amount of time set by the administrator. Also, batch mode allows auto-archiving a customer text file and a translated file not yet aged to the amount of time set by the administrator.

Another embodiment of the translation workflow management method includes generating a translation price quote for the customer at the customer interface based on the product of the number of words to be translated in the customer document and a price per word for translation set by the administrator for each individual customer. This embodiment allows the customer to quickly obtain an estimate of the cost he or she can expect to expense for the translation of his or her document prior to his or her submission of the document and payment to the translation agency.

Embodiments of the translation workflow management method further comprise automatically pre-pending a unique job number to a customer text file uploaded at a customer interface and linking the job number to a customer profile also uploaded at the customer interface. The unique job number facilitates automatically searching at least one of a plurality of customer text files, translated files, and revised translated files based on the pre-pended job number. Such searches may be used to determine an associated translator, an associated reviser, and an associated customer and to determine any other arbitrary information as defined by the administrator.

The pre-pended job number also allows automatically generating an accounting information file based on the customer text file and the customer profile. Additionally, an embodiment may automatically generate a delivery schedule based on the assigned translator's dynamic availability and the number of words in the customer text file. The accounting file is conveyed to the customer via a download by the customer at the customer interface. Likewise, the delivery schedule is conveyed with the customer text file to an assigned translator via a download by the translator at the translator interface.

In accordance with an embodiment, the translation workflow management method further includes generating an automatic email notification to the administrator when at least one event occurs of a customer uploading a text file at the customer interface and a translator uploading a translated file at the translator interface. An automatic email notification is also sent to the customer when at least one event occurs of an uploading of a translated file from the customer interface and the automatic generation of a delivery schedule. Likewise, an automatic email notification is sent to a translator when at least one event occurs of an automatic assignment of a customer text file to the translator based on the weighted value and the dynamic availability of the translator and the administrator making an infrequent assignment of a customer text file to a translator.

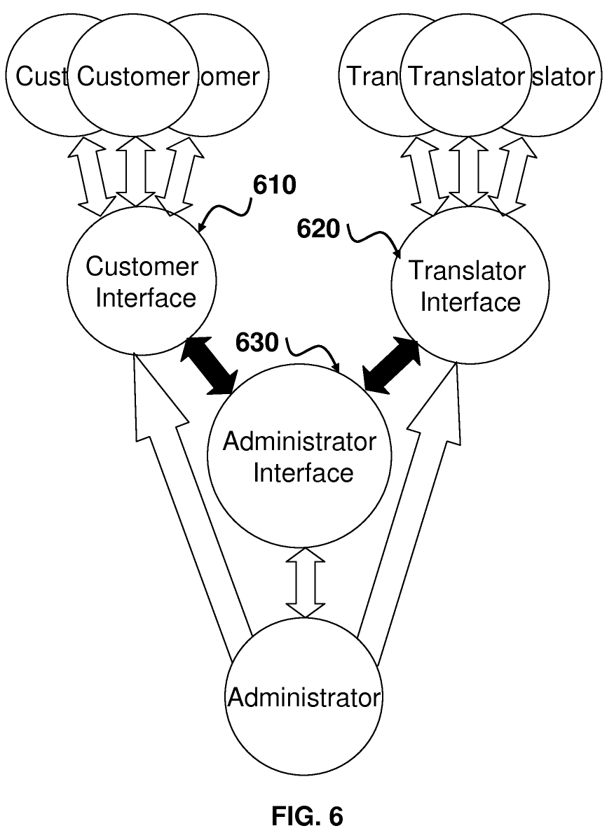

FIG. 6 depicts a diagram in accordance with an embodiment for a translation workflow management system of managing translation workflow in a translation agency between an administrator, multiple customers and multiple translators. The workflow management system includes a customer interface 610, a translator interface 620, and an administrator interface 630 connected to both the customer interface and the translator interface. The customer interface on the internet or on a network is configured to receive a customer text file and a customer profile from a customer. The solid bidirectional arrows of FIG. 6 are indicative of connections across the internet or across a local or wide area network. Other customer interfaces may also be opened according to the number of customers accessing the translation agency's website. The translator interface 620 is configured to receive a translator's daily availability and to receive a translated file from a translator based on the customer text file. The administrator interface 630 is accessible only by the administrator. The administrator interface is configured to manage the automatic assignment of a plurality of customer text files and a plurality of translated files between the customer interface and the translator interface based on a computed weighted value and a dynamic availability for each translator as described above. Also, the administrator may directly access the administrator interface or the customer and translator interfaces as depicted in FIG. 6.

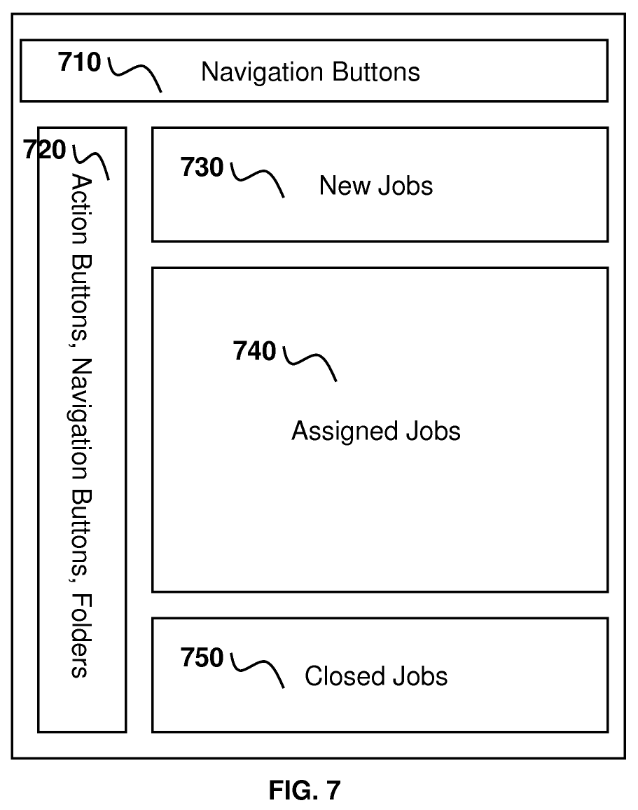

FIG. 7 depicts a diagram in accordance with an embodiment of an administrator's interface of the translation workflow management system. The administrator's interface may include internet navigation buttons 710, action buttons and folders and further navigation buttons 720, a new jobs sub-screen 730, an assigned jobs sub-screen 740, and a closed jobs sub-screen 750. The internet navigation buttons may navigate and link the administrator across the internet or a local area network to a manage jobs screen, a manage translators screen, a manage customers screen, a reports screen, a settings screen, and a user manager screen. The format of the different screens and the respective functions are discussed in detail below.

Though FIG. 7 depicts an embodiment of the administrator interface, other embodiments further include a new jobs folder and screen, an assigned jobs folder and screen, and a closed jobs folder and screen for at least one of the customer interface, the translator interface, the reviser interface and the administrator interface. Also other embodiments may include an upload and a download screen for at least one of the customer interface, the translator interface, the reviser interface and the administrator interface. The upload and download screens are configured to convey at least one of a customer text file, a translated file, and a revised translated file to another interface.

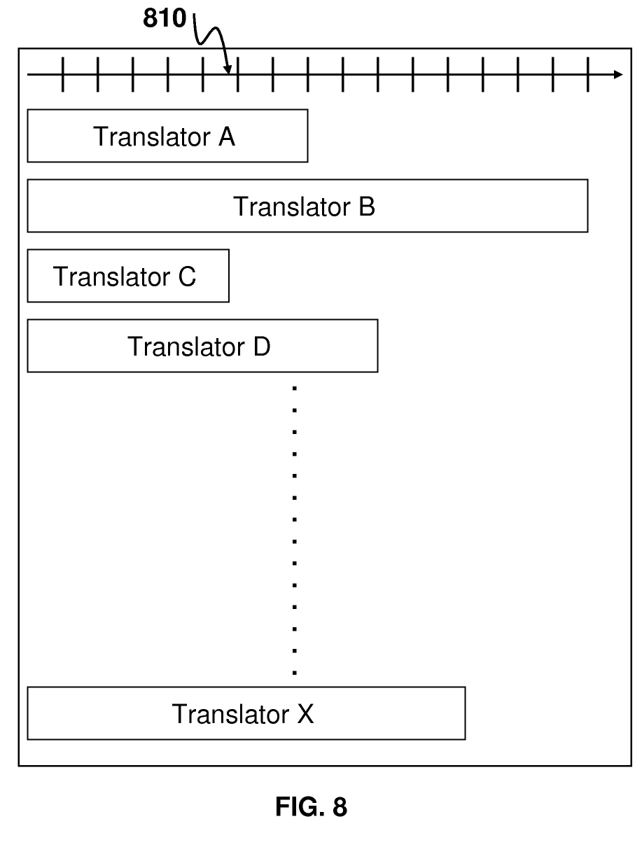

FIG. 8 depicts a diagram in accordance with an embodiment of a translator busy chart of the translation workflow management system. The translator busy chart is accessible from the manage translators screen. The translator busy chart displays a dynamic availability of multiple translators A, B, C, D, and as many as X translators on a day to day basis and includes a scale 810. The scale 810 may demarcate hours, days, or any other period of time as determined by the administrator. A translator's dynamic availability may include translator vacation, translator sick time and hours per day each translator expects to be available to translate and the employee's status as a payroll or contracted employee.

A translator weighted value chart is also accessible from the manage translator's screen. The weighted value chart displays each point value and the sum of point values for at least two of a quality rating, a speed rating, a cost rating and dependability for multiple translators. It may also display a translator's dynamic availability. The translator weighted value chart is similar in appearance to the translator busy chart in that it includes a bar of length indicative of a translator's weighted value and associated point values for each rating. Also, a scale similar to the scale 810 numerically demarcates the weighted value and associated point values.

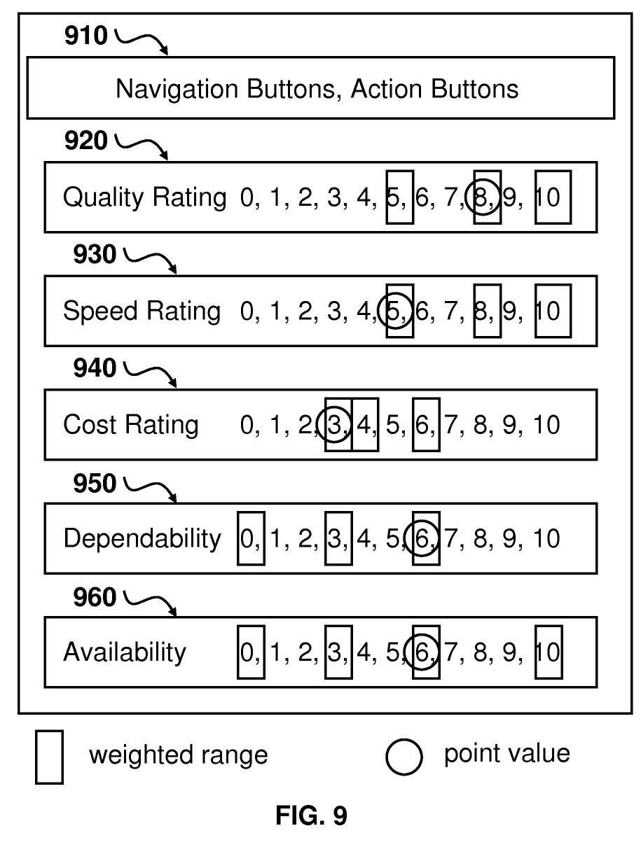

FIG. 9 depicts a diagram in accordance with an embodiment of a pull-down screen configured to allow the administrator to establish a weighted range for all translators and to select point values for each of the translators. The pull-down screen includes internet navigation and action buttons 910, the translation quality rating 920, translation speed rating 930, the translation cost rating 940, dependability 950, and dynamic availability 960. The pull-down screen is accessible from the settings navigation button of the administrator's interface. The administrator establishes a weighted range of two or more point values depicted inside squares. The administrator establishes the weighted range according to the importance a rating or factor has to the administrator relative to the other ratings or factors. Therefore the administrator may emphasize or deemphasize a rating by establishing higher point values or lower point values respectively to select from when rating a translator. The same weighted range of point values for a rating is chosen by the administrator for all translators at once.

The administrator selects a particular point value, depicted by a circle, for each specific translator one at a time. However, only the assigned point values indicated by a square may be selected by the administrator to be included in the computation of the weighted value for each translator. The administrator may change the selected point value for a translator at any time through the pull-down screen. In making the point value selection, the administrator may take into account the quality of translation the translator has performed for the administrator and also the quality of translation the translator has performed for other translation agencies. An administrator having higher priority for translation cost or dependability may establish higher point values for cost and dependability relative to translation quality.

Returning to FIG. 9, in making the selection for translation speed, the administrator may take into account translation speed measured from turn-around time of a customer text file into another language and the size of the customer text file as measured by the number of source language words it contains. In determining the number of words a customer text file contains, manual or automated and electronic methods may be employed in an embodiment. When making the selection for translation cost, the administrator may take into account the fees the translator charges to the translation agency and any overhead cost to the agency for employing the translator. In making the dependability selection, the administrator may take into account how often the translator delivers a translated file on schedule or according to contract.

The availability selection may be done automatically by the system and it may be done by the administrator on a non-routine basis. The system generates a dynamic availability for each translator using a translator's availability profile and the result of a number of words already assigned for translation to a translator divided by a translator's translation speed initially set by the administrator. The translator's availability profile includes factors keeping the translator from being immediately available for work such as vacation, sick time, personal time and training and mentoring time but may not include the work the translator currently has been assigned. Therefore, the system performs a calculation of the number of words assigned to the translator divided by the translator's translation speed. The result is a quantity of time which is added to the availability indicated by the translator's profile to generate the dynamic availability.

An embodiment of the disclosed system also includes a time zone converter configured to automatically convert a time stamp for all uploaded customer text files to the local time of the administrator and to convert a time stamp for all uploaded translated files to the local time of the administrator. The time zone converter automatically facilitates tracking files from submission time to completion time. The administrator may access the time zone converter through the settings navigation button on the administrator interface.

The settings navigation button also links the administrator to a sub-screens comprising a business message from the administrator to all customers and a legal terms and conditions click through or click wrap agreement to all customers, a message to all translators and a legal terms and conditions click through agreement to all translators. Therefore, independent contractors may contract with the administrator and the translation agency through their click through of the terms of the agreement thus displayed. Also, non-disclosure and privacy terms click wrap agreements may be included to protect the administrator's customers.

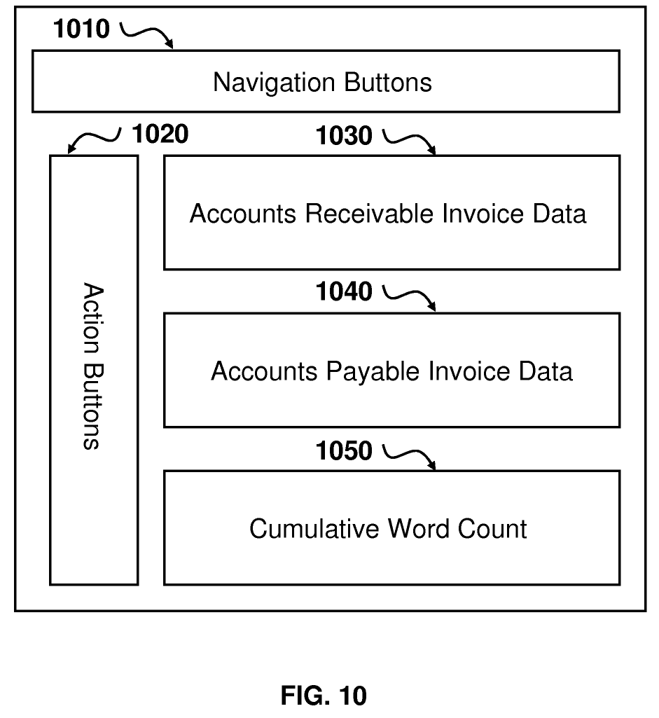

FIG. 10 depicts a diagram in accordance with an embodiment of a screen of accounting information in the translation workflow management system. FIG. 10 includes internet navigation buttons 1010, action buttons 1020 including buttons linked to an accounts receivable folder and buttons linked to an accounts payable folder, an accounts receivable invoice data sub-screen 1030, an accounts payable invoice data sub-screen 1040, and a cumulative word count utility 1050 for automatically computing a cumulative number of words translated for a customer. The accounts receivable invoice data includes invoices automatically generated for multiple customers and the accounts payable invoice data includes invoices automatically generated for multiple translators. The accounting information sub-screens are accessible from the reports navigation button on the administrator's interface. Accounting sub-screens are automatically populated with customer, translator, and file information from the translation workflow management system. Invoices are automatically generated by the translation workflow management system from the accounting information generated therein.

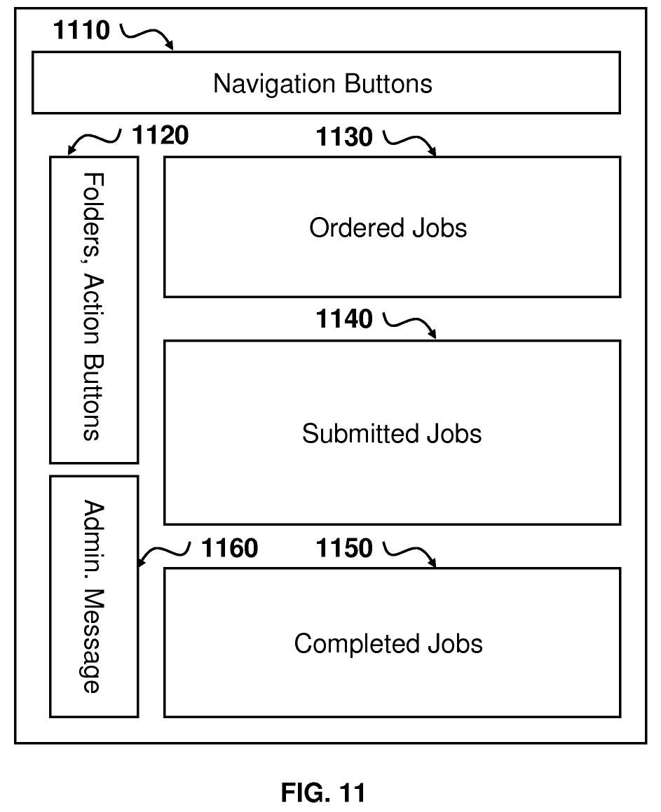

FIG. 11 depicts a diagram in accordance with an embodiment of a format for a management screen used by the customer, the translator and the administrator of the translation workflow management system. The screen includes internet navigation and action buttons 1110, folders and action buttons 1120, an ordered jobs sub-screen 1130, a submitted jobs sub-screen 1140, a completed jobs sub-screen 1150, and an administrative message sub-screen 1160. Customers upload their documents to be translated at the ordered jobs sub-screen together with other pertinent information about the job. A customer may upload up to 5 text files, also known as documents, at one time. Documents submitted by the customer show up on the submitted jobs sub-screen. In the same way, completed jobs are displayed when clicking on the submitted jobs button. At any time, the administrator may change an administrative message which appears the same for all customers and the same for all translators.

Continuing with FIG. 11, the administrator selects the completed jobs to be delivered or conveyed to clients by checking the corresponding boxes in the completed jobs sub-screen and then clicks on a ‘move to customer’ action button. Each job is then automatically sent to the folder belonging to the client who originally submitted the job, and they are automatically notified by e-mail that their transaction is ready for download. Jobs already delivered to clients are indicated by a green check-mark circle icon next to each.

The translated version of a document is indicated by a special note automatically appended to the document name, for example: “—Spanish.” This is an automatic process performed instantly by the system when translators upload their translations. Customer files are stored on the translation agency web server for a period of time for the customer's convenience, so they may come back and download their translations again anytime.

In an embodiment, the assigned jobs screen of the customer interface, the translator interface, the reviser interface and the administrator interface further comprises at least one sub-screen including a customer name, a job file name automatically pre-pended with a unique job number, a number of total words in a text file, a purchase order number, a translator assigned to work on a text file, and an estimated delivery date.

An embodiment of the disclosure includes a computer program product comprising a computer readable medium having computer useable program code executable to perform operations for translation workflow management of a translation agency. The operations of the computer program product include uploading a customer text file and a customer profile at a customer interface in communication with a translator interface and an administrator interface. When a customer uploads a new document to the web site, the administrator selects it by checking the appropriate box, and then clicks on an ‘assign translator’ button to send the job to a translator, thereby assigning the job.

The system then displays the newly assigned job with the customer name, customer purchase order number, the number of words in the job, the translator assigned to the job, and the estimated delivery date. The estimated delivery date is calculated automatically based on the current work load of the translator, the daily capacity of that translator, and the number of words in the newly assigned document. The estimated delivery date is then e-mailed to the customer automatically by the system.

The system notifies the translator automatically, telling them that they have a new assignment, and requests that the translator “acknowledge and accept” the job. On the same screen, the system also indicates to the administrator whether or not this has been done by displaying the appropriate symbol indicating the translator acknowledgement status for each job. After the translator has translated a document, he or she may upload up to five documents to the system at one time. The translator may then view all his or her completed jobs.

Another operation of the computer program product includes generating a translation price for a customer at the customer interface based on a product of a number of words to be translated in the customer text file and a price per word for translation initially set by an administrator. Yet another operation of the computer program product includes computing a weighted value parameter for each of a plurality of translators based on point values for at least one of a quality rating, a speed rating, a cost rating and a dependability rating. Each of the ratings is set by the administrator. The computer program product operations further include automatically generating a dynamic availability parameter for each translator based on a translator's availability profile and by using a quotient of the total number of words to be translated by a translator divided by a translator's daily translation capability initially set by the administrator.

An embodiment of the operations of the computer program product includes updating the weighted value parameter when changing a point value used to compute the weighted value. Also the dynamic availability parameter is updated by the operation of the computer program when changing a translator's availability profile and when changing the translator's assigned words and daily translation capability.

The operations of the computer program product further include displaying all files, all calculated numbers, all computed parameters, and all settings set by the administrator on the administrator interface in a plurality of screens, sub-screens, pull-down menus and folders. The administrator may then manually select a translator to assign the job to from a pull down menu, while simultaneously viewing a “Translator Busy Chart” which graphically displays how busy each translator is, given the currently assigned work load. The administrator may also, at the same time, send a brief note or comment to the translator regarding the job being assigned. However, customer text files are typically and routinely assigned to translators based on a translator's weighted value and dynamic availability and the number of words to be translated in the customer text file.

When the translator completes the assigned job and uploads the translated document, the job is either automatically delivered to the client, or transferred to a reviser for a final revision and editing prior to delivery to the client based on a translator's weighted value relative to a revised threshold value initially set by the administrator for all translators.

In an embodiment of the disclosure, the translator has the option to select the job, and “Accept & Initiate” the work. Only after clicking an ‘accept & initiate’ button placed adjacent the ‘new jobs’ sub-screen (see format of FIG. 7), indicating his agreement with the conditions summarized below, does the document become available for download to the translator. “By clicking on the ‘accept & initiate’ button, you indicate your acceptance of this translation job, your agreement with the condition of non-circumvention, and the condition to maintain all of the information contained in the document(s) being translated in the strictest confidence.” The foregoing translator conditions are also modifiable by the administrator at any time. After indicating his acceptance of the conditions, the new document becomes available for download to the translator. A new job which has not yet been downloaded is marked with a ‘new’ symbol for easy identification.

The operations of the computer program product also include automatically generating the data necessary to create an accounting invoice based on information from the customer text file and the customer profile and the number of words to be translated in at least one customer text file submitted for translation. After the job has been delivered to the client, it appears in the reports section where the system generates the data necessary to create an invoice, allowing the administrator to export it to a file which is compatible with industry standard accounting software.

When a translation job is completed and finally delivered to the customer, the translation workflow management system, generates an invoice for the particular job or jobs performed indicating the customer name, the purchase order number, the name of the document(s) being billed, the number of words for each, and the total cost. This is all done automatically, eliminating the need for manual data input to generate invoices for jobs performed.

Also, conveying a plurality of customer text files and a plurality of translated files over the internet between multiple customers and multiple translators via the administrator interface is included in an embodiment. The administrator interface is accessible only to the administrator. The translation price, the translated file, the accounting invoice, and the delivery schedule are also downloaded to the customer at the customer interface in an embodiment.

In accordance with the disclosure, persons or entities desiring to purchase products or services from another person or entity may be known as customers, consumers and clients. Persons and entities desiring to render services and provide products to such other purchasers may be known as contractors, employees, and also assignees. The present disclosure further comprises a client taking a job as an assignee and an assignee submitting a job as a client in a peer-to-peer assignment of jobs. Therefore, clients and assignees may transact business over the internet and any electronic communications network between electronic devices and data processing machines to transform data and information from one state or form into another as disclosed herein.

Embodiments of the disclosed method and system allow transactions between a client and an assignee where the client chooses an assignee for completing his or her job. Allowing the client to choose a most qualifying assignee from among multiple candidates allows the client to get the best job performance possible from a pool of assignees given the client's desired job performance preferences. Therefore, the present disclosure enables a business to consistently and systematically provide its customers with the best possible quality, in the shortest period of time, at the lowest possible cost, at any given time, given its current talent pool.

Furthermore, in accordance with an embodied method and system, the client may categorize his/her job into a job type category. The client's job is assigned to the highest qualifying assignee within that job category allowing the client to hire a specialist. Also, the client may chose an assignee by prioritizing at least one job performance rating category including a quality rating, a speed rating and a cost rating in accordance with the client's business model and practices. For instance, a client who operates his/her business in commodity markets with small profit margins may choose to emphasize cost and quality over speed of delivery. The client will therefore be allowed to choose from assignees who have previously been rated high in quality and inexpensive by other clients for whom the assignees have done work.

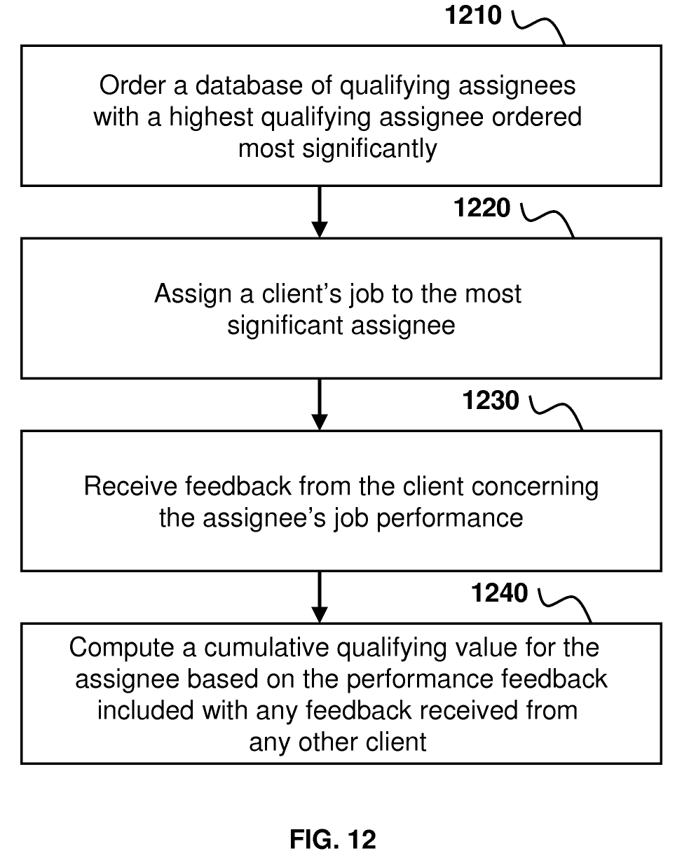

FIG. 12 depicts a flow chart of a method in accordance with an embodiment for intelligent job assignment between multiple assignees and at least one client. The flow chart includes ordering 1210 a database of qualifying assignees with a highest qualifying assignee ordered most significantly. Assignees are qualified by feedback received from clients for whom they have performed at least one job (The term ‘feedback’ is treated as a singular noun herein, but as a non-count noun can not be preceded by an ‘a’ or ‘an’ in proper usage). Assignee performance feedback from a client may be given in lexicographical or numerical form. For instance, the client may give feedback for the assignee's job performance as falling into an unsatisfactory or a ‘meets expectations’ category, or an ‘exceeds expectations’ category, etc. where an ‘exceeds expectations’ category is most significant. Alternatively, a client may assign a numerical value within a performance rating category such as quality, speed, and cost to an assignee's performance with higher performance being assigned a higher numerical value. An assignee getting higher numerical feedback from the client is more significant than an assignee getting lower numerical feedback. Therefore the ordering 1210 may include numerical ordering and lexicographical ordering through bubble sorting and library sorting methods and other methods known in the art of computer sorting algorithms. For instance, the database may be queried to find a highest qualifying assignee. The database may be sorted until the highest qualifying assignee is in a most significant position within the database. The database is again queried and sorted on the next highest qualifying assignee. Querying and sorting continues until all assignees have been arranged from the highest qualifying assignee to a lowest qualifying assignee.

The flow chart of FIG. 12 also includes assigning 1220 a client's job to the most significant assignee and receiving feedback 1230 from the client concerning the assignee's job performance. To include job performance history in the embodied method, a cumulative qualifying value is computed 1240 for the assignee based on the performance feedback from the client included with any feedback received from any other client. This way the client is able to obtain the most qualified assignee for his or her job.

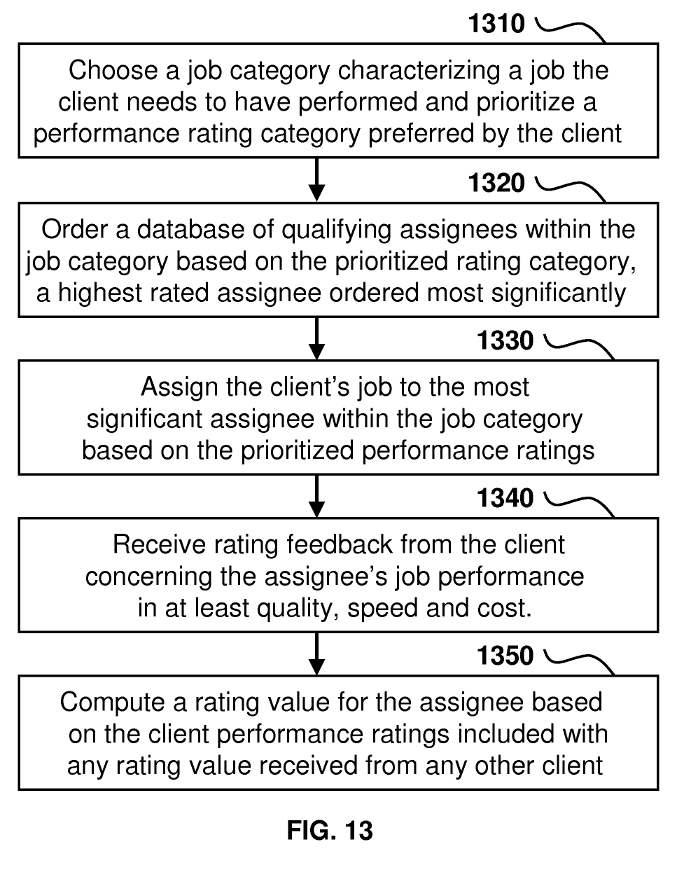

FIG. 13 depicts the operations of a computer program product in accordance with an embodiment for intelligent job assignment between multiple assignees and at least one client. The operations of the computer program product include choosing 1310 a job category characterizing a job the client needs to have performed and prioritizing a performance rating category preferred by the client. Job type categories may include accounting and finance, education, general labor, government, customer service, human resources, language translation, legal services, manufacturing, health care, retail, real estate, skilled trades, software, technical support, writing and any other category suggested by a client or assignee.

Also, the computer program product of FIG. 13 may include ordering 1320 a database of qualifying assignees within the job category based on the prioritized rating category where a highest rated assignee is ordered most significantly. The computer program product further includes receiving 1340 rating feedback from the client concerning the assignee's job performance in quality, cost and dependability. Average ratings for the assignee are computed 1350 based on the client performance ratings included with average feedback from any other client.

In accordance with an embodiment, a client's job may be marked unavailable for further assignment when it is assigned to an assignee. Also, an assignee may be marked unavailable for further assignment while he or she is working on a particular job. This is a straightforward process that becomes more complicated for large jobs and complex jobs that may be categorized into more than one job category. Therefore, large jobs may be broken up into smaller sub-jobs and complex jobs may be segmented into smaller sub-jobs falling into multiple job categories. To keep track of the smaller and segmented sub-jobs, unique job numbers pre-pended automatically to each of the sub-jobs. Numbering schemes which may be indicative of a parent job's number are also included in an embodiment.

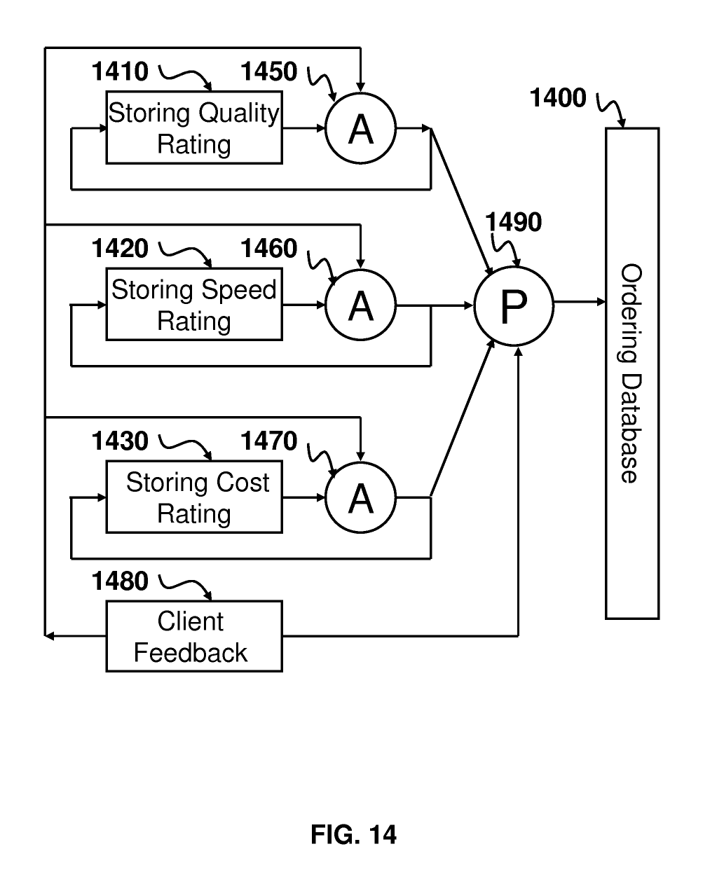

FIG. 14 depicts a diagram of a method in accordance with an embodiment for intelligent job assignment further including averaging and storing assignee job performance ratings and prioritizing an averaged rating. The diagram includes a database 1400 that is ordered from a highest qualifying assignee to a lowest qualifying assignee where the highest assignee is the most significant assignee. The diagram also includes a storing a quality rating 1410, storing a speed rating 1420, and storing a cost rating 1430 in a computer memory. The diagram also includes averaging 1450 the stored quality rating 1410 with client feedback for quality, averaging 1460 the stored speed rating 1420 with client feedback for assignee job completion speed, and averaging 1470 the stored cost rating 1430 with client feedback for cost. The output of the quality average 1450, the output of the speed average 1460 and the output of the cost average 1470 are stored in memory as depicted and also prioritized 1490 for ordering the database 1400. In an alternate embodiment, client feedback 1480 is added, but not averaged, with stored ratings prior to prioritization 1490. This allows computing a cumulative qualifying value for an assignee based on the client performance feedback 1480 included with any stored feedback received from any other client. The cumulative qualifying value may be used in ordering the database 1400.

In accordance with an embodiment, an assignee may be awarded a qualifying value for promptly deciding not to take an assigned job. An assignee may make such a decision based on the complexity of the job, personal qualifications or schedule. A prompt decision by the assignee allows the client to assign the job to another qualifying assignee in a timely manner. Therefore, the assignee is rewarded with a point value that may improve his speed rating feedback average.

Also, in accordance with an embodiment, a client may blacklist an assignee whom the client does not wish to do business with again based on any factor chosen by the client. Therefore, the blacklisted assignee is blocked from the database ordering only for that specific client. The client may provide a reason for the blacklisting to allow the assignee to respond. However, one client's blacklist is not shared with other clients so an assignee blacklisted for one client may not automatically be blacklisted for any other client. Clients may remove a blacklisted assignee from his or her blacklist without prejudice at any time and without any comment.

In the event a client does not provide feedback for an assignee's job performance (null rating values), an assignee may be awarded a qualifying point value based on the assignee's average client feedback for all his/her job performance ratings. This may prevent an assignee's average ratings from decreasing when the client either is too busy to provide feedback or is generally happy with the assignee's job performance.

An embodiment of the present disclosure includes a method for a client and an assignee to negotiate a job price prior to the assignee's acceptance of an assignment. The assignee proposes a job price to the client based on his or her assessment of the job. The client and the assignee may then adjust the job price up or down without justification but assignment does not take place until the client's price matches the assignee's price or they otherwise agree on a price for the job. Alternatively, the client may propose an initial job price and open up bidding between at least a first and a second most significant assignee. It is then the client's prerogative to accept or reject one or all of the assignee's bids. Once the client has accepted an assignee's bid, the job is assigned to the winner bidder at the accepted price.

Email notification to the client and to (an) assignee(s) is a feature of an embodiment. Email notifications may be generated automatically to at least two most significant assignees in a job category when a client opens up a job for bidding. Also, an email notification may be generated automatically to the client when an assignment is made to an assignee and an assignee decides not to take an assigned job as discussed above. Furthermore, an email notification may be automatically sent to an assignee when assigning a client's job to the assignee.

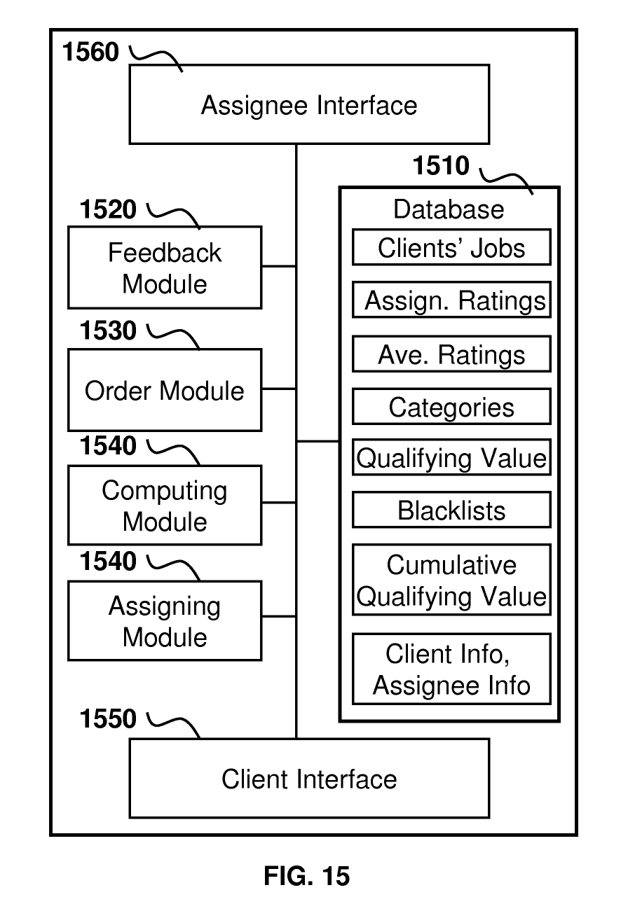

FIG. 15 is a block diagram of a system in accordance with an embodiment for intelligent job assignment between multiple assignees and at least one client. The system includes a database 1510 comprising clients' jobs, assignee ratings, assignee average ratings, job categories, qualifying values, blacklists, cumulative qualifying values and client information and assignee information. Clients' jobs may include descriptions of clients' jobs, information necessary for an assignee to complete a client's job and also may include the job itself. The database 1510 may be stored in a computer memory. The system also includes a feedback module 1520, an order module 1530, a computing module 1540, an assigning module 1540 and a client interface 1550 and an assignee interface 1560. The client interface 1550 and the assignee interface 1560 may include a computer screen, keyboard and computer. The client interface 1550 and the assignee interface 1560 may also include dumb terminals comprising computer output and input where the computer itself is located remotely and/or distributed across a network.

In a system embodiment of FIG. 15, as depicted by interconnecting lines, all modules are in communication with each other and in communication with the client and assignee interfaces and the database. The feedback module 1520 of FIG. 15 is configured to receive feedback from the client concerning the assignee's job performance. It is therefore configured to receive numerical feedback and alphabetical feedback. The order module 1530 is configured to order any and all data groups in the database according to values given to the data by the feedback module 1520. The ordering module 1530 may order through bubble sorting and library sorting methods and other methods known in the art of computer sorting algorithms. The computing module 1540 is configured to add and take averages of an assignee's performance ratings including performance ratings received from all previous clients for whom an assignee has performed work. The computing module is also programmable to compute a cumulative qualifying value based on criteria preferred by the client. The cumulative qualifying value may include feedback from the client and all previous clients for whom an assignee has performed work. The assigning module 1540 may pre-pend a unique job number to each client job and assign client jobs to assignees.

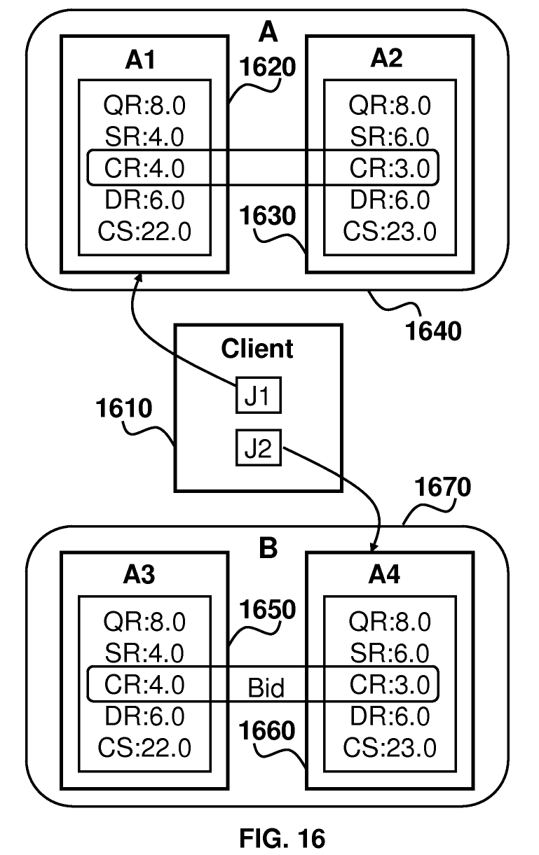

FIG. 16 depicts a client assigning multiple jobs to multiple assignees in two job categories in accordance with an embodiment of the present disclosure. The depiction includes a client 1610, a first assignee 1620 and a second assignee 1630 in job A category 1640. The depiction also includes a third assignee 1650 and a forth assignee 1660 in job B category 1670. The client 1610 initially has two jobs J1 and J2 to assign within the system. The client 1610 categorizes his job J1 into job A category 1640, for example language translation services from English to Spanish and categorizes his second job J2 into job B category 1670, for example legal services.

The first assignee 1620 has a cumulative qualifying value score of 22 coming from a prior job assignment where a prior client gave him a quality rating (QR) of 8, a speed rating (SR) of 4, a cost rating (CR) of 4 and a dependability rating (DR) of 6. The second assignee 1630 has a cumulative qualifying value score of 23 coming from a prior job assignment where the prior client gave him a QR of 8, an SR of 6, a CR of 3, and a DR of 6. Therefore the assignee database in job A category 1640 places the second assignee 1630 more significantly than the first assignee 1620 based on their respective cumulative qualifying scores. Accordingly, the client's first job may get assigned to the second assignee 1630 on this basis.

However, consistent with the client's 1610 preferences and business practices, cost is the primary concern among the four rating factors and may be prioritized by the client 1610. Therefore, though the second assignee 1630 has an overall higher cumulative score than the first assignee 1620, the first assignee 1620 has a higher cost rating than the second assignee 1630. Based on cost, job J1 is awarded to the first assignee 1620. Based on the cumulative score, job J1 would be awarded to the second assignee 1630. Therefore, if the client 1610 does not choose a priority rating, the job J1 may be assigned to the second assignee 1630.

In job B category 1670, the third assignee 1650 has a qualifying value score of 22 coming from a prior job assignment where a prior client gave him an 8 in QR, a 4 in SR, a 4 in CR and a 6 in DR. The fourth assignee 1660 has a qualifying score of 23 coming from a prior job assignment where the prior client gave him an 8 in QR, a 6 in SR, a 3 in CR and a 6 in DR. Therefore, the assignee database in job B category 1670 places the fourth assignee 1660 more significantly than the third assignee 1650 based on their respective cumulative qualifying scores and places the third assignee 1650 more significantly than the forth assignee 1660 based on cost priority.

On the other hand, the client 1610 has chosen in the job B category 1670 to open up the job J2 to bidding cost among the most significant assignees, which in this case are the third assignee 1650 and the fourth assignee 1660. When the client 1610 opens up a job assignment to bidding, the cost rating is overridden and the cumulative qualifying score may also be overridden at the option of the client 1610. Accordingly, the fourth assignee 1660 has a chance to bid a lower price for job J2 than the third assignee 1650 and get awarded J2 by the client 1610.

In the event that all assignees have identical average ratings within the client's preferred rating category, the client may also choose to assign his or her job based on the most recent assignee performance ratings in his or her preferred rating category. This is in accordance with an embodiment of the present disclosure where all an assignee's ratings and averages are stored in the database. Alternatively, the client may simply open up the job for bidding between the most qualified assignees within a job type category.

Returning to FIG. 16, when the first assignee 1620 has completed his assigned job, J1, and the client 1610 is queried for feedback concerning the first assignee's 1620 performance of the job, the client 1610 gives the first assignee 1620 a quality rating of 8, a speed rating of 6, a cost rating of 8, and a dependability rating of 6. Therefore, the first assignee 1620 has average ratings of QR:8 (unchanged), SR:5 (average of 4 and 6), CR:6 (average of 4 and 8), and a DR:6 (unchanged). However, the first assignee 1620 now has a cumulative qualifying value score of 50 (22 plus 28).

When the fourth assignee 1660 has completed his assigned job J2 and the client 1610 is queried for feedback concerning his performance of J2, the client 1610 may choose not to provide feedback. Since it would be unfair to penalize the fourth assignee 1660 for a null entry from the client, the fourth assignee 1660 is awarded qualifying point values equal to his average ratings. In this case the fourth assignee 1660 therefore gets 23 cumulative qualifying points for a cumulative score of 46 points but his average ratings do not change.

Though the fourth assignee 1660 initially had a higher qualifying score than the first assignee 1620, the fourth assignee 1660 does not get assigned jobs from job category A because he is not qualified as an English to Spanish translator. However, when the client 1610 needs to assign a legal services job, the fourth assignee 1660 is assigned the client's second job J2 because he was one of the most qualified assignees within job category B, legal services, and outbid his competitor, the third assignee 1650.

Therefore, the disclosed method and system for intelligent job assignment between multiple assignees and at least one client, provides the client with a plethora of options for customizing the selection of an assignee to his or her job across job types and assignee performance preferences. The disclosed method and system is configurable to large jobs and complex jobs and assignments to more than one assignee at a time. It also allows maximum flexibility for an assignee as an independent contractor, a full-time or part-time employee or even as an agent for another person or entity.

The disclosed method and system is merit based and therefore encourages top performance from assignees. The disclosed method and system also allows negotiating and bidding between the client and assignee(s) and therefore encourages fair pay and reasonable schedules for both the client and the assignee. Because the disclosed method is fully automated in a digital computer system, little to no intervention is required to maintain the system after initial set-up and clients and assignees may transact business at any time of the day, any day of the year.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing description is illustrative of the present disclosure in one or more particular embodiments, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An intelligent job assignment method between multiple assignees and at least one client through an electronic communications network, the method comprising:
ordering a database of a plurality of qualifying assignees with a highest qualifying assignee ordered most significantly;
assigning a client's job to the most significant assignee;
receiving feedback from the client concerning an assignee's job performance; and
to computing a cumulative qualifying value for the assignee based on the performance feedback included with any feedback received from any other client.

2. The intelligent job assignment method of claim 1, further comprising:
choosing at least one job category characterizing a type of work the client needs to have performed;
ordering the database within the at least one job category; and
assigning the client's job to the most significant assignee within the category.

3. The intelligent job assignment method of claim 1, wherein receiving feedback from the client concerning an assignee's job performance further comprises:
receiving at least one of a quality rating, a speed rating and a cost rating category from the client concerning the assignee's job performance;
averaging at least one of the assignee's ratings with any other ratings received from any other client providing feedback for the assignee; and
storing the assignee's ratings and the assignee's rating averages and the assignee's cumulative qualifying values in the database to be used in assigning a client's job.

4. The intelligent job assignment method of claim 3, further comprising:
prioritizing at least one rating category characterizing a type of work based on the client's preferences and business model;
ordering the database within the at least one prioritized rating category; and
assigning a client's job to the most significant assignee within the prioritized rating category.

5. The intelligent job assignment method of claim 3, wherein computing a cumulative qualifying value for the assignee based on the performance feedback added to any feedback received from any other assignee further comprises:
to establishing a weighted range of at least two point values for each rating according to the prioritizing;
receiving a selection of one of the point values from the client for each rating; and
automatically computing the qualifying value from a sum of the feedback received from the client added to the feedback received from any other client.

6. The intelligent job assignment method of claim 1, wherein ordering a database of a plurality of qualifying assignees, ordering a highest qualifying assignee most significantly, further comprises:
arranging the database with the highest qualifying assignee first;
sorting the database to find a next highest qualifying assignee and inserting the next highest qualifying assignee next in the database; and
continuing the sorting until all assignees have been arranged from the highest qualifying assignee to a lowest qualifying assignee.

7. The intelligent job assignment method of claim 1, wherein the assigning a client's job to the most significant assignee further comprises:
making the client's job unavailable for further assignment; and
marking the assignee unavailable for further assignment until receiving feedback from the client.

8. The intelligent job assignment method of claim 1, further comprising:
establishing an assignee's availability profile comprising a daily capability and a daily availability including the assignee vacation, assignee personal time, assignee sick time and hours per day the assignee expects to be available to work and the assignee's status as a payroll or contracted employee; and
updating an assignee's dynamic availability when at least one of an event occurs of assigning an additional job to an assignee, changing an assignee's availability profile, and removing an assignee from the assignee pool.

9. The intelligent job assignment method of claim 1, further comprising:
reassigning a job to second assignee when a first assignee decides not to take an assigned job; and
awarding a qualifying value to the first assignee for prompt reassigning.

10. The intelligent job assignment method of claim 1, further comprising:
blacklisting an assignee based on any factor chosen by the client;
removing a blacklisted assignee from the ordering for the client; and
allowing a blacklisted assignee in the ordering for any other client not blacklisting the assignee.

11. The intelligent job assignment method of claim 1, wherein receiving feedback from the client concerning an assignee's job performance further comprises awarding a qualifying point value for the assignee based on the assignee's average client feedback when the client's feedback is a null value.

12. The intelligent job assignment method of claim 1, further comprising:
proposing a job price to the assignee initially set by the client;
adjusting the job price based on a countering job price set by the assignee; and
negotiating an agreed job price between the client and the assignee until the client's price matches the assignee's price.

13. The intelligent job assignment method of claim 1, further comprising:
opening bidding for a client's job between at least a first and a second most significant assignee;
proposing a job price initially set by the client to the at least first and second most significant assignee;
accepting a bidding price from one of the at least first and second assignee, the accepting done by the client;
adjusting the job price based on the price accepted; and
assigning the job to the assignee making the accepted price.

14. The intelligent job assignment method of claim 1, further comprising:
pre-pending automatically a unique job number to a client's job uploaded at a client's interface and linking the job number to a client profile also uploaded at the client's interface.

15. The intelligent job assignment method of claim 1, further comprising:
segmenting a large client job into a first plurality of smaller sub-jobs in the same job category for assignment to a plurality of assignees and pre-pended a unique job number on each sub-job; and
breaking up a diverse client job into a plurality of smaller sub-jobs in diverse job categories for assignment to a second plurality of assignees and pre-pended a unique job number on each sub-job.

16. The intelligent job assignment method of claim 1, further comprising:
generating an automatic email notification to at least two most significant assignees in a job category when a client opens up a job for bidding;
generating an automatic email notification to the client when an event occurs of an assignment to an assignee and an assignee deciding not to take an assigned job; and
generating automatic email notification to an assignee when assigning a client's job to the assignee.

17. The intelligent job assignment method of claim 1, further comprising a client taking a job as an assignee and an assignee submitting a job as a client in a peer-to-peer assignment of jobs.

18. A system for intelligent job assignment between multiple assignees and at least one client through an electronic communications network, the system comprising:
an ordered database comprising a cumulative score of job performance ratings for each of the multiple assignees and information concerning the client;
a feedback module in communication with the database, the feedback module configured to receive feedback from the client concerning the assignee's job performance and store the feedback in the database;
a computing module in communication with the feedback module and the database, the computing module configured to compute an assignee's qualifying score based on the performance feedback and any stored feedback received from an other client; and
a job assignment module in communication with the database, the job assignment module configured to assign a client's job to the most significant assignee based on the assignee's qualifying score.

19. The system for intelligent job assignment between multiple assignees and at least one client of claim 18, further comprising:
an assignee interface in communication with the database, the assignee interface configured on a computer screen comprising the assignee's client ratings, average ratings, and cumulative qualifying value; and
a client interface in communication with the database, the client interface configured on a computer screen comprising a client's past jobs, jobs assigned, and jobs not yet assigned.

20. A computer program product comprising a computer readable medium having computer useable program code executable to perform operations for intelligent job assignment between multiple assignees and at least one client through an electronic communications network, the operations of the computer program product comprising:
choosing a job category characterizing a job the client needs to have performed and prioritizing an assignee performance rating category preferred by the client;
ordering a database of a plurality of qualifying assignees within the job category based on the prioritized rating category, a highest rated assignee ordered most significantly;
assigning the client's job to the most significant assignee within the job to category based on the prioritized performance rating;
receiving rating feedback from the client concerning the assignee's job performance in at least a quality, speed and cost category; and
computing a performance rating value for the assignee based on the performance rating feedback included with any performance rating value received from any other client.
